(19) United States
(12) Patent Application Publication
(10) Pub. No.: US 2021/0073695 A1
(43) Pub. Date: Mar. 11, 2021

(54) PRODUCTION SCHEDULING SYSTEM AND METHOD

(71) Applicant: Synergies Intelligent Systems, Inc. Taiwan Branch, Taipei (TW)

(72) Inventor: Tsung-Yao Chang, Taipei (TW)

(21) Appl. No.: 17/006,810

(22) Filed: Aug. 29, 2020

Related U.S. Application Data
(60) Provisional application No. 62/896,059, filed on Sep. 5, 2019.

(51) Int. Cl. G06Q 10/06; G06Q 10/00; G06Q 50/04; G06F 16/215; G06N 20/00

(52) U.S. Cl. CPC G06Q 10/06312; G06Q 10/20; G06Q 10/06393; G06N 20/00; G06Q 50/04; G06F 16/215; G06Q 10/067

(57) ABSTRACT

A production scheduling system including a scheduling calculation host, multiple databases connected to the scheduling calculation host, and a user terminal. The scheduling calculation host includes a data cleaning module, adapted for cleaning production data from the multiple databases; a pre-processing calculation module, adapted for pre-processing and calculating the production data from the data cleaning module to obtain an extraction data; and a reinforcement learning model, adapted for producing an optimal scheduling decision according to a score function and the extraction data. The system can perform calculations based on various production data and quickly produce an optimal scheduling decision to simplify production scheduling operations and improve enterprise production efficiency.

### FIELD OF THE INVENTION

The invention relates to production management technology, in particular to a production scheduling system and a production scheduling method.

### BACKGROUND OF THE INVENTION

Production scheduling is to arrange the production sequence for each production task, optimize the production sequence, and optimize the selection of production equipment under the premise of considering the capacity and equipment and with a certain amount of materials, so as to reduce waiting time and balance the production load of machines and workers, thereby optimizing production capacity, improving production efficiency and shortening production cycle.

At present, the material planning and scheduling of various industries are usually executed by ERP or MES systems. Specifically, static decision-making parameters are input by humans based on experience to adjust the production plan of the production equipment. Especially, if the production scheduling factors, such as temporary order queue jump, plan changes, delayed arrival of auxiliary materials and insufficient raw materials, changes, it requires complex intervention by experienced and specialized personnel, and results will be output by simple calculated from the system. However, this traditional production management method has low efficiency and high labor costs, and the calculation results often do not conform to business logic and require manual adjustments.

Therefore, there is an urgent need to provide an improved production scheduling system and method to overcome the above drawbacks.

### SUMMARY OF THE INVENTION

An objective of the present invention is to provide a production scheduling system that can perform calculations based on various production data and quickly produce an optimal scheduling decision to simplify production scheduling operations and improve enterprise production efficiency.

Another objective of the present invention is to provide a production scheduling method that can perform calculations based on various production data and quickly produce an optimal scheduling decision to simplify production scheduling operations and improve enterprise production efficiency.

To achieve the above-mentioned objectives, the present invention provides a production scheduling system including a scheduling calculation host, multiple databases connected to the scheduling calculation host, and a user terminal. The scheduling calculation host includes:

a data cleaning module, adapted for cleaning production data from the multiple databases;

a pre-processing calculation module, adapted for pre-processing and calculating the production data from the data cleaning module to obtain an extraction data; and

a reinforcement learning model, adapted for producing an optimal scheduling decision according to a score function and the extraction data.

Preferably, the reinforcement learning model is adapted for producing multiple scheduling decisions for each of different simulating environments according to the score function and the extraction data, and judging the optimal scheduling decision for each stimulating environment.

Preferably, the reinforcement learning model is adapted for judging the optimal scheduling decision by virtue of a reward mechanism.

Preferably, the data cleaning module is adapted for cleaning and filtering useless data in the production data of the databases.

Preferably, the pre-processing calculation module is adapted for calculating and extracting the extraction data suitable for the reinforcement learning model.

Preferably, the extraction data comprises production time, order delivery date, machine maintenance status, urgency, and current production status.

Preferably, the system further includes an information feedback module respectively connected with the user terminal and the reinforcement learning model, wherein the reinforcement learning model is adapted for adjusting results of scheduling decisions in real time, according to the information feedback module.

Accordingly, the present invention further provides a production scheduling method including steps of:

(1) cleaning production data from the multiple databases;

(2) pre-processing and calculating the production data from the data cleaning module to obtain an extraction data; and

(3) creating a reinforcement learning model and producing an optimal scheduling decision according to a score function and the extraction data.

Preferably, the step (3) includes producing multiple scheduling decisions corresponding to each of different simulating environments according to the score function and the extraction data, and judging the optimal scheduling decision for each stimulating environment.

Preferably, the step (3) further includes constructing a scheduling virtual environment according to the extraction data and the different simulating environments, and constructing multiple sub-learning models according to the multiple scheduling decisions; determining whether a key performance indicator (KPI) of each scheduling decision is better than a historical KPI, if yes, rewarding the corresponding sub-learning model; and judging optimization degree of each scheduling decision, thereby producing the optimal scheduling decision.

Preferably, the step (1) includes cleaning and filtering useless data in the production data of the databases.

Preferably, the step (2) comprises calculating and extracting the extraction data suitable for the reinforcement learning model.

Preferably, the extraction data comprises production time, order delivery date, machine maintenance status, urgency, and current production status.

Preferably, the method further includes receiving feedback information from the user terminal and adjusting results of scheduling decisions in real time according to the feedback information.

In comparison with the prior art, the production scheduling system and method of the present invention use the reinforcement learning model to clean, filter, and pre-process the production data according to the production data and specific algorithms, thereby training the model to quickly produce the optimal scheduling decision. As a result, the scheduling process of production management is simplified to assist users in improving production efficiency and reducing production costs.

### BRIEF DESCRIPTION OF THE DRAWINGS

The accompanying drawings facilitate an understanding of the various embodiments of this invention. In such drawings:

FIG. 1 is a schematic view of a production scheduling system of according to an embodiment of the present invention;

FIG. 2 is a structure diagram of a scheduling calculation host of the production scheduling system of according to an embodiment of the present invention;

FIG. 3 is a schematic view of a production scheduling system of according to another embodiment of the present invention;

FIG. 4 is a flowchart of a production scheduling method of according to an embodiment of the present invention;

FIG. 5 is a flowchart showing of the optimal scheduling decision produced by the reinforcement learning model according to an embodiment of the present invention; and

FIG. 6 is a flowchart of a production scheduling method of according to another embodiment of the present invention.

### DETAILED DESCRIPTION OF ILLUSTRATED EMBODIMENTS

A distinct and full description of the technical solution of the present invention will follow by combining with the accompanying drawings. The present invention is aimed at providing a production scheduling system and a production scheduling method that can perform calculations based on various production data and quickly produce an optimal scheduling decision to simplify production scheduling operations and improve enterprise production efficiency.

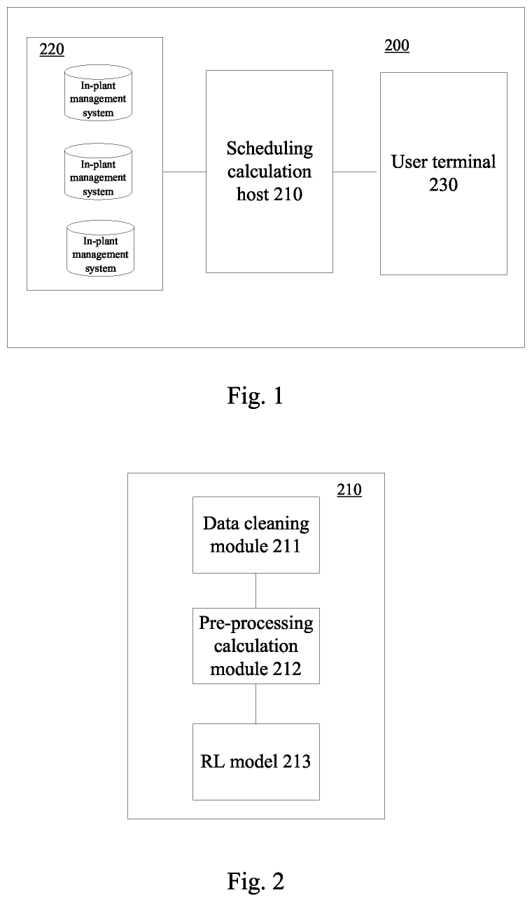

As shown in FIG. 1, a schematic diagram of an embodiment of the production scheduling system 200 of the present invention is shown. The production scheduling system 200 includes a scheduling calculation host 210, multiple in-plant management systems (not shown) connected to the scheduling calculation host 210, and a user terminal 230. Each in-plant management system may include one or more databases, thereby forming a database 220 of production source data. The user terminal 230 may include a user interface, such as a display or a tablet computer, connected to the scheduling calculation host 210. The scheduling calculation host 210 is configured to perform a series of processing to the production data from the database 220, and then generate an optimal scheduling decision to the user interface for the user's reference.

Specifically, the scheduling calculation host 210 is autonomously connected to a plurality of in-plant management systems to collect and aggregate production information related to production conditions, such as: material accounting system, production management system, bill of material (BOM), customer requirements, etc., as the calculation basis of the subsequent scheduling calculation host 210. Preferably, the material accounting system may be an ERP system or a SAP system, and the production management system may be an MES system.

As shown in FIG. 2, the scheduling calculation host 210 includes a data cleaning module 211, a pre-processing calculation module 212, and a reinforcement learning (RL) model 213. Specifically, the data cleaning module 211 is configured to clean the production data from multiple databases 220. The pre-processing calculation module 212 is configured to perform pre-processing and calculating the production data from the data cleaning module 211 to obtain extraction data. The reinforcement learning model 213 is configured to produce an optimal scheduling decision based on a score function and the extraction data.

Specifically, the original production data is serially connected and input to the data cleaning module 211 for cleaning. More specifically, the useless data in the production data is cleaned and eliminated, and the most representative product and production path are extracted from the production data by cleaning and filtering the data in the calculation layer, and then are input to the subsequent scheduling calculation host 210, which reduces the data processing requirements and speeds up the back-end calculation.

The pre-processing calculation module 212 is configured to calculate and extract data suitable for the input specifications of the subsequent reinforcement learning model 213, including production time, order delivery date, machine maintenance status, urgency, and current production status. For example, if the material is insufficient, the pre-processing calculation module 212 can generate the optimal work order according to the due date and importance of the order; or if the material is missing, the pre-processing calculation module 212 alerts to notify the user to proceed early emergency measures, such as emergency purchases, etc. In addition, the pre-processing calculation module 212 will automatically split orders according to the number of work orders, so as to avoid excessive production of existing work orders. Preferably, the pre-processing calculation module 212 is also configured to perform ETL processing on the production data.

The reinforcement learning model 213 is configured to produce multiple scheduling decisions for each of different simulating environments according to a score function and the extraction data, and determine a corresponding optimal scheduling decision for each environment. It's necessary to consider maximum production capacity, shortest production cycle, and highest equipment utilization rate, when setting the different simulating environments. Specifically, the reinforcement learning model is configured to produce a corresponding optimal scheduling decision for each environment according to the score function and the extraction data, and then model training and learning is performed according to the target parameters defined in the background. As the production data changes, and the environment changes accordingly, the reinforcement learning model 213 can generate corresponding optimal scheduling decision for the user's reference. Specifically, the conditions of various simulating environments can be limited, such as the setting of the maintenance and test to the machine at a specific period, the restriction of the fixture, the flexible setting to the production time, and the integration of work orders, etc. Specifically, the score can be calculated by the following formula: Score₁=β₀+β₁Feature₁+ . . . +βᵢFeatureᵢ, wherein β is the weight, and Feature is the variable, such as remaining time due, lead time, importance of work orders, and process steps, etc. The user may select the variables in advance and score them one by one, and obtain the optimal scheduling decision through the weighted scores and the calculation of the aforementioned scores.

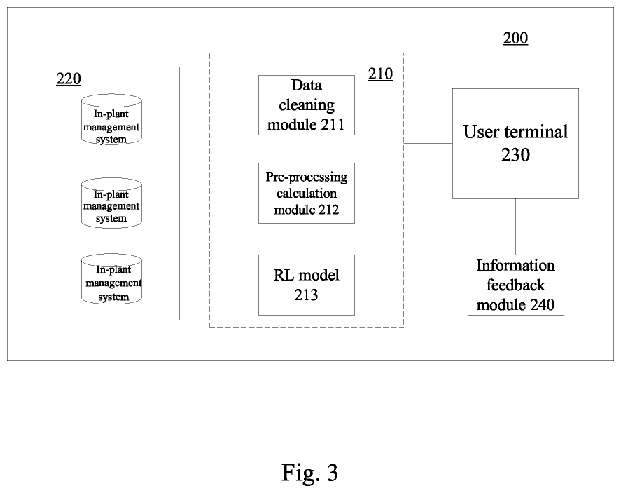

As a preferred embodiment, as shown in FIG. 3, the production scheduling system 200 further includes an information feedback module 240 respectively connected with the user terminal 230 and the reinforcement learning model 213, whereby the reinforcement learning model can adjust the result of the scheduling decisions in real time. Specifically, the feedback information returned by the information feedback module 240 to the reinforcement learning model 213 includes the change of the production sequence made by users, limiting conditions added by users, and order queue jump. By means of the information feedback module 240, any changes to the original conditions including machines, production capacity, materials, and personnel, etc. will be returned to the back-end database, and fed back to the reinforcement learning model 213 as the basis for learning decision rules, so as to adjust the scheduling decisions in real time. Users may also dynamically search for historical scheduling decision-making solutions and re-select the most appropriate production management scheduling plan. Preferably, after multiple scheduling decisions and the optimal scheduling decision are produced, the report is automatically generated and displayed on the user terminal.

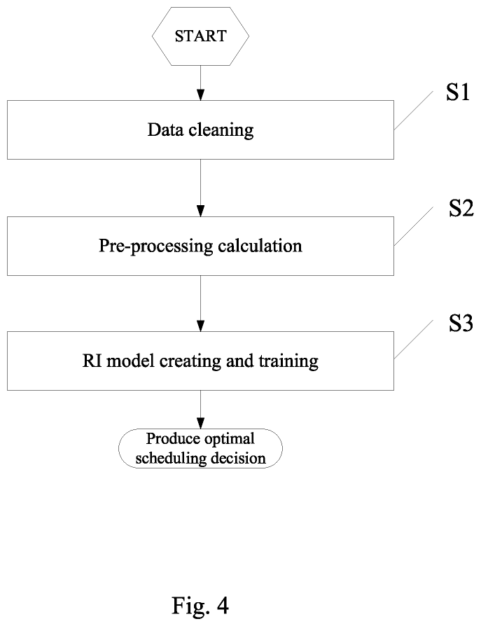

Accordingly, a production scheduling method of the present invention is executed on the above production scheduling system. As an embodiment shown in FIG. 4, the method includes the following steps:

S1, data cleaning: cleaning production data from the multiple databases;

S2, pre-processing calculation: pre-processing and calculating the production data from the data cleaning module to obtain an extraction data; and

S3, RI model creating and training: building a RI model and producing an optimal scheduling decision according to a score function and the extraction data.

Specifically, in the step S1, the original production data is serially connected and input to the data cleaning module 211 for cleaning. More specifically, the useless data in the production data is cleaned and eliminated, and the most representative product and production path are extracted from the production data by cleaning and filtering the data in the calculation layer, and then are input to the subsequent scheduling calculation host 210, which reduces the data processing requirements and speeds up the back-end calculation.

In the step S2, the method includes calculating and extracting data suitable for the input specifications of the subsequent reinforcement learning model 213, including production time, order delivery date, machine maintenance status, urgency, and current production status. For example, if the material is insufficient, the pre-processing calculation module 212 can generate the optimal work order according to the due date and importance of the order; or if the material is missing, the pre-processing calculation module 212 alerts to notify the user to proceed early emergency measures, such as emergency purchases, etc. In addition, the pre-processing calculation module 212 will automatically split orders according to the number of work orders, so as to avoid excessive production of existing work orders. Preferably, the pre-processing calculation module 212 is also configured to perform ETL processing on the production data.

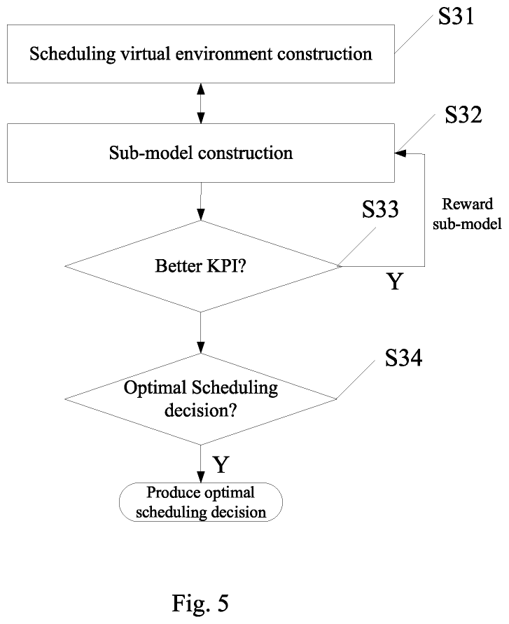

In the step S3, the reinforcement learning model 213 generates multiple scheduling decisions under multiple different simulating environments according to a score function and the extraction data, and determines a corresponding optimal scheduling decision for each environment. Referring to FIG. 5, the step of generating the scheduling decisions by the reinforcement learning model 213 includes the following sub-steps:

S31, scheduling virtual environment construction: constructing a scheduling virtual environment according to the extraction data and the different simulating environments;

S32, sub-model construction: constructing multiple sub-learning models according to the multiple scheduling decisions;

S33, KPI judgment: determining whether the key performance indicator (KPI) of each scheduling decision is better than the KPI of the historical scheduling decisions, if yes, rewarding the corresponding sub-learning model by means of a Reward algorithm. In addition, the user may also weight and score each KPI in advance, and produce the optimal scheduling decision in the subsequent steps according to each weighted score.

S34, scheduling decision optimization: judging the degree of optimization of each scheduling decision, thereby producing the optimal scheduling decision.

After the optimal scheduling decisions corresponding to each environment are determined, then the model training and learning can be performed according to the target parameters defined in the background. As the production data changes, and the environment changes accordingly, the reinforcement learning model 213 can generate corresponding optimal scheduling decision for the user's reference.

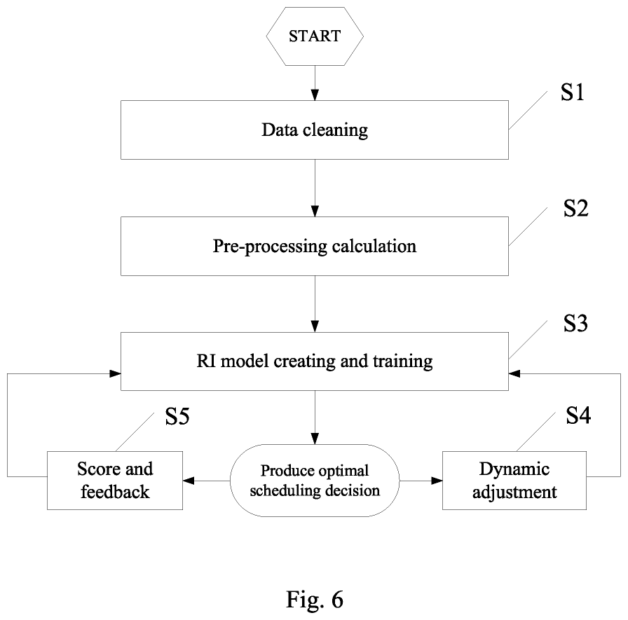

As a preferred embodiment, as shown in FIG. 6, the production scheduling method further includes the following steps:

S4, dynamic adjustment: receiving feedback information from the user terminal and adjusting results of scheduling decisions in real time according to the feedback information. Specifically, the feedback information returned by the information feedback module 240 to the reinforcement learning model 213 includes the change of the production sequence made by users, limiting conditions added by users, and order queue jump. By means of the information feedback module 240, any changes to the original conditions including machines, production capacity, materials, and personnel, etc. will be returned to the back-end database, and fed back to the reinforcement learning model 213 as the basis for learning decision rules, so as to adjust the scheduling decisions in real time. Users may also dynamically search for historical scheduling decision-making solutions and re-select the most appropriate production management scheduling plan.

Preferably, after multiple scheduling decisions and the optimal scheduling decision are produced, a report is automatically generated and displayed on the user terminal.

In conclusion, the production scheduling system and method of the present invention use the reinforcement learning model to clean, filter, and pre-process the production data according to the production data and specific algorithms, thereby training the model to quickly produce the optimal scheduling decision. As a result, the scheduling of production management is simplified to assist users in improving production efficiency and reducing production costs.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A production scheduling system, comprising a scheduling calculation host, multiple databases connected to the scheduling calculation host, and a user terminal, and the scheduling calculation host comprising:
a data cleaning module, adapted for cleaning production data from the multiple databases;
a pre-processing calculation module, adapted for pre-processing and calculating the production data from the data cleaning module to obtain an extraction data; and
a reinforcement learning model, adapted for producing an optimal scheduling decision according to a score function and the extraction data.

2. The production scheduling system according to claim 1, wherein the reinforcement learning model is adapted for producing multiple scheduling decisions for each of different simulating environments according to the score function and the extraction data, and judging the optimal scheduling decision for each stimulating environment.

3. The production scheduling system according to claim 2, wherein the reinforcement learning model is adapted for judging the optimal scheduling decision by virtue of a reward mechanism.

4. The production scheduling system according to claim 1, wherein the data cleaning module is adapted for cleaning and filtering useless data in the production data of the databases.

5. The production scheduling system according to claim 1, wherein the pre-processing calculation module is adapted for calculating and extracting the extraction data suitable for the reinforcement learning model.

6. The production scheduling system according to claim 5, wherein the extraction data comprises production time, order delivery date, machine maintenance status, urgency, and current production status.

7. The production scheduling system according to claim 1, further comprising an information feedback module respectively connected with the user terminal and the reinforcement learning model, wherein the reinforcement learning model is adapted for adjusting results of scheduling decisions in real time, according to the information feedback module.

8. A production scheduling method, comprising steps of:
(1) cleaning production data from the multiple databases;
(2) pre-processing and calculating the production data from the data cleaning module to obtain an extraction data; and
(3) creating a reinforcement learning model and producing an optimal scheduling decision according to a score function and the extraction data.

9. The production scheduling method according to claim 8, wherein the step (3) comprises producing multiple scheduling decisions corresponding to each of different simulating environments according to the score function and the extraction data, and judging the optimal scheduling decision for each stimulating environment.

10. The production scheduling method according to claim 9, wherein the step (3) further comprises constructing a scheduling virtual environment according to the extraction data and the different simulating environments, and constructing multiple sub-learning models according to the multiple scheduling decisions; determining whether a key performance indicator (KPI) of each scheduling decision is better than a historical KPI, if yes, rewarding the corresponding sub-learning model; and judging optimization degree of each scheduling decision, thereby producing the optimal scheduling decision.

11. The production scheduling method according to claim 8, wherein the step (1) comprises cleaning and filtering useless data in the production data of the databases.

12. The production scheduling method according to claim 8, wherein the step (2) comprises calculating and extracting the extraction data suitable for the reinforcement learning model.

13. The production scheduling method according to claim 12, wherein the extraction data comprises production time, order delivery date, machine maintenance status, urgency, and current production status.

14. The production scheduling method according to claim 8, further comprising receiving feedback information from the user terminal and adjusting results of scheduling decisions in real time according to the feedback information.
